(19) United States
(12) Patent Application Publication
(10) Pub. No.: US 2006/0066458 A1
(43) Pub. Date: Mar. 30, 2006

(54) Perimeter of sign warning system

(76) Inventor: Eric James Samuelsen, Stewartstown, PA (US)

Correspondence Address: Eric J. Samuelsen, 3575 Stewartstown Road, Stewartstown, PA, 17363, US

(21) Appl. No.: 11/228,096

(22) Filed: Sep. 16, 2005

Related U.S. Application Data
(60) Provisional application No. 60/614,864, filed on Sep. 30, 2004.

(51) Int. Cl. G08G 1/095

(52) U.S. Cl. 340/907

(57) ABSTRACT

A perimeter-of-sign warning system is provided having a number of novel features. The provided system is defined by a warning flasher that encompasses the perimeter of a road sign. Its enclosure has provisions for mounting the sign, and a cross member provides additional support to the sign. Furthermore, the enclosure maintains perpendicularity between the face of the sign and the light output from the warning flasher, regardless of the orientation of the sign. The system also allows airflow through it, thus minimizing possible misalignment due to wind. Tamperproof hardware and plexiglas/Lexan panels provide protection against unauthorized access and vandalism. The warning flasher incorporates maintenance free solid-state light emitting diodes into its design. Its ‘light chaser’ flash pattern is designed to more effectively draw attention to the road sign to which it is associated.

### CROSS-REFERENCE TO RELATED APPLICATIONS

Not Applicable

### STATEMENT REGARDING FEDERALLY SPONSORED RESEARCH AND DEVELOPMENT

Not Applicable

### REFERENCE TO SEQUENTIAL LISTING, A TABLE, OR A COMPUTER PROGRAM LISTING COMPACT DISC APPENDIX

Not Applicable

### BACKGROUND OF THE INVENTION

1. Field of the Invention

This application relates to warning flasher systems—in particular to warning flashers associated with road signs. From this point forward, the term ‘road sign’ shall refer to any regulatory, warning or guide sign that is used for traffic control.

2. Background Art

Warning flashers have long been used to complement road signs. These flashers typically consist of one or more round flashing beacons located either above or below the sign. In some installations, beacons are located above and below the sign. Older designs coupled an incandescent lamp with a diffracting lens, while most current designs incorporate solid-state lamps [Light Emitting Diodes [LEDs]].

In recent years, Light Emitting Diodes have become brighter, more robust and less expensive. These technological advances have improved the reliability and visibility of the warning beacon—and have opened the door for new warning flasher designs. Some new designs incorporate flashers into the road signs themselves.

One design option positions warning flasher elements on the background of a road sign. Another option incorporates individual LEDs into the border of the sign—one LED element at each corner of the sign.

There is an inherent weakness to both of these design options—the amount of space available on the face of the sign for the warning flasher is limited. This limitation results in the use of smaller flasher elements, thus reducing the effectiveness of such elements.

The goal for any warning flasher system is to provide effective warning to approaching traffic. Regulatory agencies' response to increased traffic volume, speed and driver distractions has been to mandate the use of larger—and in some cases more—warning flashers. Where 6- and 8-inch beacons were once used, 12-inch beacons are now specified. In locations where single beacons were typically used, now dual flashers are installed.

To some extent, the incorporated flasher design options detailed above represent a step backward. While the agency focus has been on larger beacons with increased visibility, these designs—with smaller flasher elements—ultimately provide less visibility.

### SUMMARY OF THE INVENTION

The warning system embodiment of the present invention contains a number of novel features.

In the preferred embodiment of this design, the warning flasher is independent of, but borders the road sign to which it is associated. By moving the flasher system off of the face of the sign, there is no limitation on the size of the flasher. A larger area can thus be dedicated to the warning system—without compromising the effectiveness of the sign itself.

Additionally, the preferred embodiment incorporates a mounting bracket for the road sign. With this feature, homogeneity is maintained between the sign and the warning system. The chance for misalignment is eliminated—as the light output from the warning system remains perpendicular to the face of the sign, regardless of the sign's orientation.

The preferred embodiment also provides support to the road sign to which it is associated. In standard installations, these signs are exposed to abuse—vandalism, wind, weather, etc. The conventional [two point] mounting system for such signs does little to prevent damage from such abuse. By providing cross support to the sign, the preferred embodiment minimizes these effects. Furthermore, air slots between the sign and the warning system enclosure prevent the system from possible misalignment due to wind gusts.

Additionally, the system incorporates independently controlled solid-state light banks into its design. The system can thus provide a variety of flasher output patterns.

The preferred embodiment of this invention employs a ‘light chaser’ pattern—each block on each light panel turns on and off sequentially. This pattern is designed to more effectively draw attention to the road sign to which it is associated.

### BRIEF DESCRIPTION OF THE DRAWINGS

FIG. 1A is a front view of the perimeter of sign warning system—including a representative road sign—made in accordance with the present invention;

FIG. 1B is a close-up side view of section A-A′ of the embodiment in FIG. 1A;

FIG. 1C is a close-up side view of section B-B′ of the embodiment in FIG. 1A;

FIG. 2 is an exploded front view of the system—less road sign and gaskets;

FIG. 3 is a back view of the warning system—less road sign;

FIG. 4A is a cutaway side view of a typical installation for the warning system;

FIG. 4B is a view from the top of the installation shown in FIG. 4A;

FIG. 5A is the front view of the light panel sub assembly;

FIG. 5B is a side view of the light panel sub assembly illustrated in FIG. 5A;

FIG. 5C is a close-up side view of section C-C′ of the light panel sub assembly shown in FIG. 5B;

FIG. 6A is the front view of the solid-state light panel;

FIG. 6B is a side view of the solid-state light panel shown in FIG. 6A;

FIG. 7 is the front view of the perimeter of sign warning system—with representative road sign—showing a stop action view of the light chaser flasher scheme;

FIG. 8A represents a general starting position for the warning flasher elements;

FIG. 8B represents the flasher element position directly following that in FIG. 8A;

FIG. 8C shows the transition from light block 9 back to light block 1.

FIG. 9 is a representative ‘light chaser’ circuit.

### DETAILED DESCRIPTION OF THE INVENTION

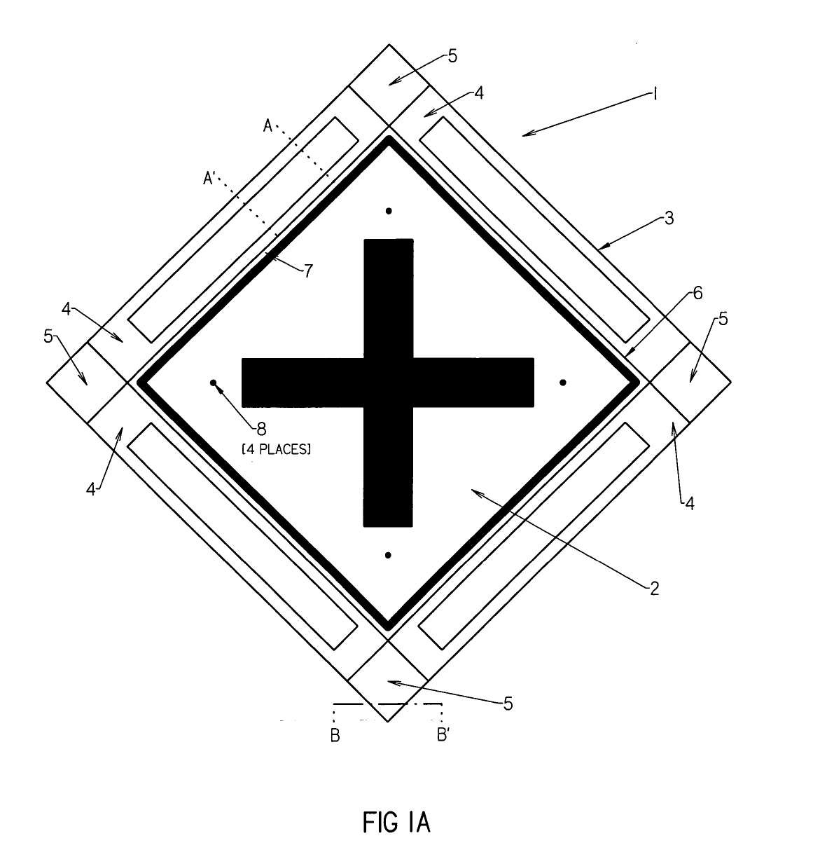

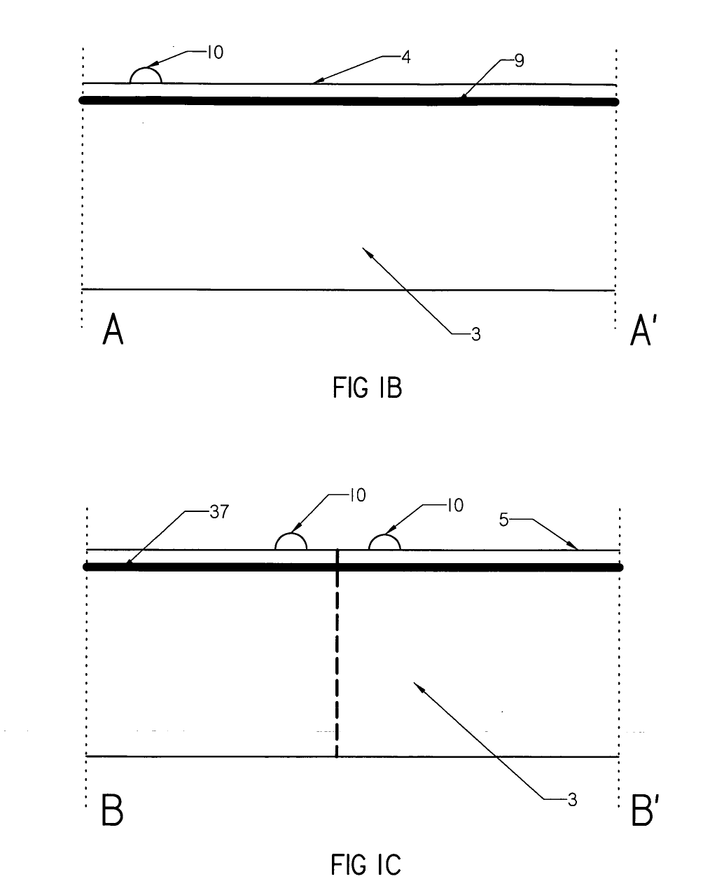

The Perimeter of Sign Warning System 1 shown in FIGS. 1A, 1B, and 1C represents a preferred embodiment of the invention. The warning system 1 consists of a stainless steel enclosure 3, to which four light panel sub assemblies 4, four service panels 5, and a [representative] road sign 2, are attached. The light panel sub assemblies 4 and service panels 5 are attached to the stainless steel enclosure 3 with tamperproof stainless steel screws 10. Gaskets 9 and 37 provide a weatherproof seal between the light panel sub assemblies 4, the service panels 5, and the stainless steel enclosure 3. Although stainless steel is specified, the enclosure 3—and panels 4 and 5—may be constructed using other materials, including nonferrous metals, fiberglass, plastic, composites, and other grades of steel.

The inner perimeter 6 of the stainless steel enclosure 3 is sized so that there is a uniform gap 7 between the enclosure 3 and the road sign 2. This gap 7 allows for airflow through the warning system 1, so that misalignment due to wind gusts is minimized. The road sign 2 is secured to the stainless steel enclosure 3 with stainless steel hardware 8.

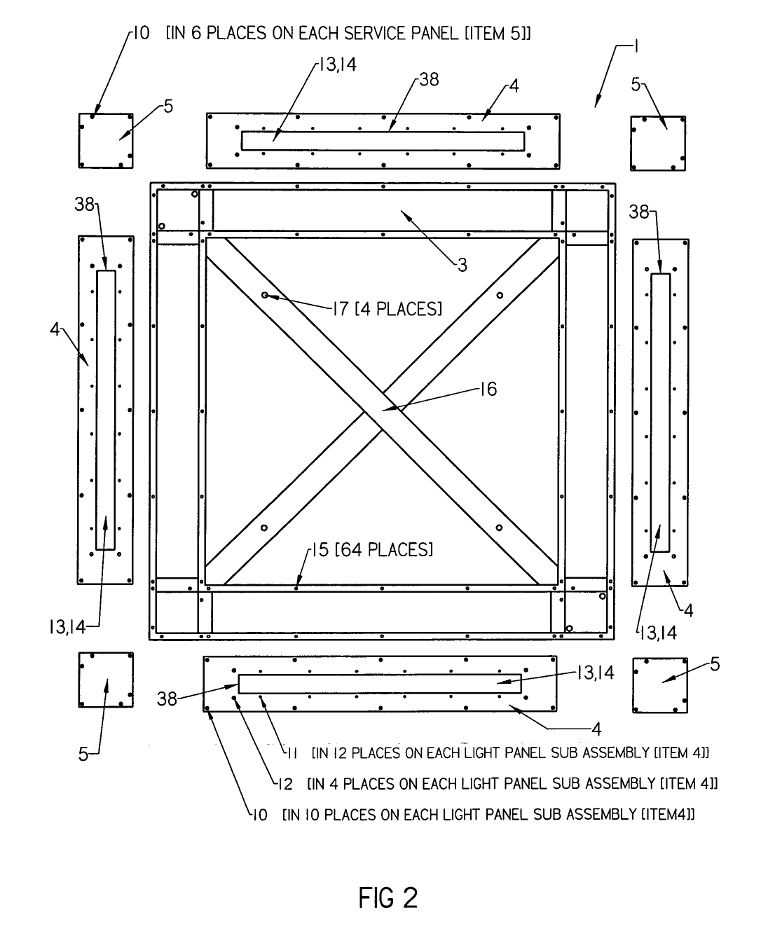

An exploded view of the warning system 1 is shown in FIG. 2—less road sign 2 and gaskets 9 and 37 shown in FIGS. 1A, 1B, and 1C. The light panel sub assemblies 4, and service panels 5 are mounted to the stainless steel enclosure 3 with a total of sixty-four (64) tamperproof stainless steel screws 10. Each light panel sub assembly 4 uses ten screws 10, while each service panel 5 requires six of these screws 10. The enclosure 3 is equipped with sixty-four (64) threaded inserts 15 to ensure proper engagement of the tamperproof stainless steel screws 10. The service panels 5 allow access to the interior of the enclosure 3 for mounting the warning system, and for maintenance.

Each light panel sub assembly 4 contains solid-state light panels 14 and a plexiglas/Lexan shield 13. These are secured to the light panel sub assembly 4 with tamperproof stainless steel screws 11 and 12. A slot 38 cut in the front of the light panel sub assembly 4 allows light through from the solid state light panels 14.

The preferred embodiment of the stainless steel enclosure 3 also includes a sign support 16. This stainless steel cross member has holes 17 for mounting the road sign 2 in FIG. 1A. The sign support 16 provides support to each corner of the road sign 2, and also allows the warning system 1 to maintain near perpendicularity between the face of the road sign 2 and the illuminated output from light panel sub assemblies 4, as illustrated in FIG. 1A.

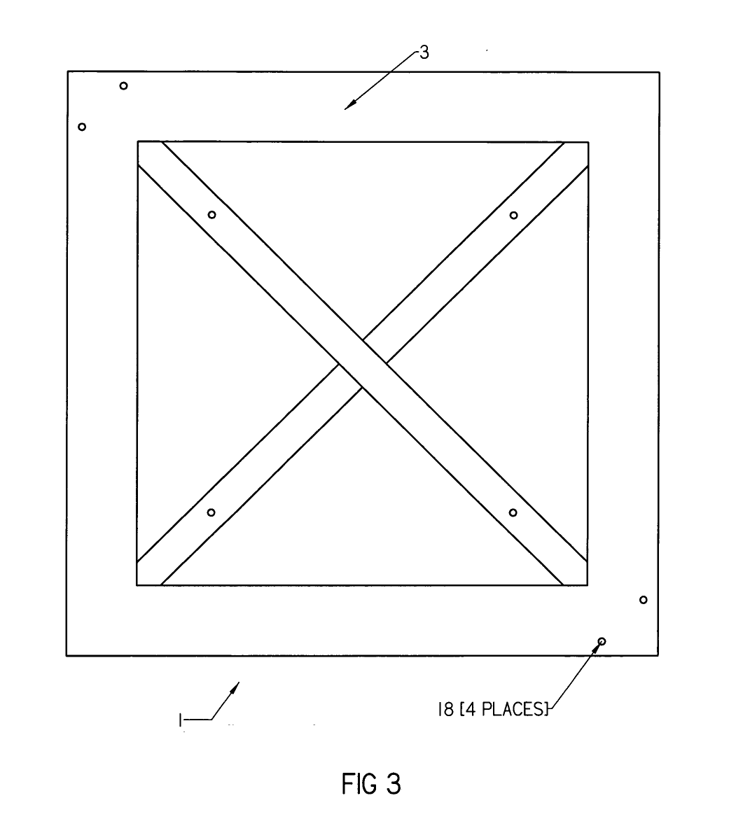

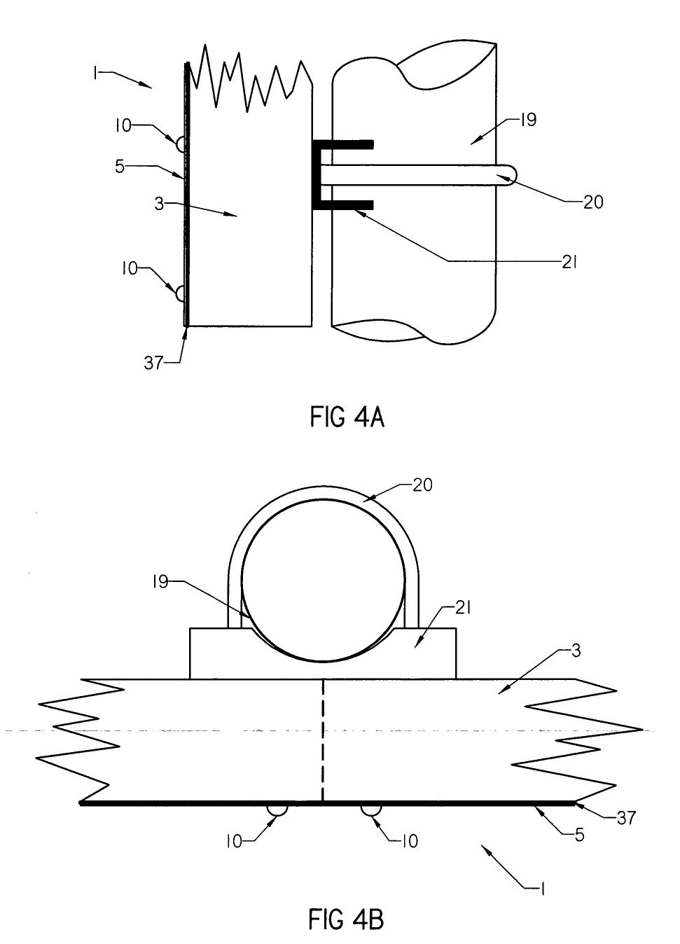

The back view of the enclosure 3 is shown in FIG. 3, and a typical warning system installation is shown in FIGS. 4A and 4B. Mounting holes 18 on the back of the enclosure 3 allow the warning system 1 to be mounted to a round pole 19 with stainless steel U-bolts 20. The stainless steel enclosure 3 has provisions for two U-bolts 20—one each at the top and bottom. Separate mounting brackets 21 assure consistent clamping around the pole 19. Once assembled to the round pole 19, tamperproof stainless steel hardware 10 and service panels 5 on the front of the warning system 1 protect the U-bolts 20, and associated hardware from unauthorized access. Gasket 37 provides a weatherproof seal between the enclosure 3 and the service panel 5.

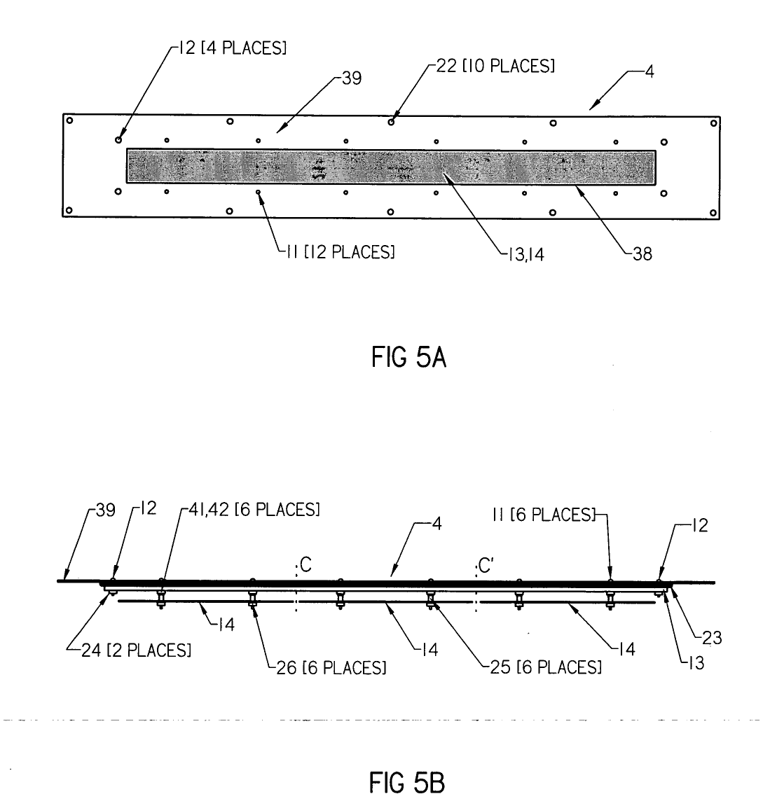

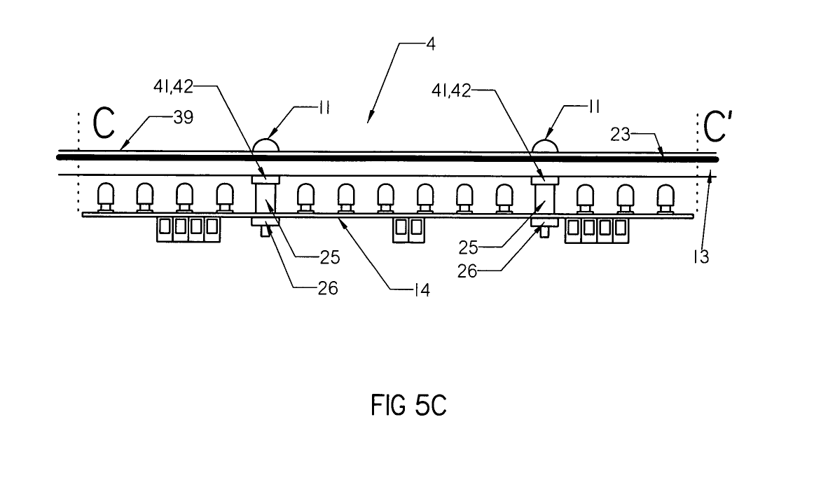

The light panel sub assembly 4 is detailed in FIGS. 5A, 5B, and 5C. This sub assembly consists of a stainless steel panel 39, gasket 23, plexiglas/Lexan shield 13, three solid state light panels 14, and tamperproof stainless steel mounting hardware 11, 12, 24, 26, 41, 42. On each light panel sub assembly, the gasket 23 is sandwiched between the plexiglas/Lexan shield 13 and the stainless steel panel 39. These are secured with tamperproof stainless steel screws 11 and 12, stainless steel nuts 24, 41 and washers 42 prior to assembling the solid-state light panels 14 to the light panel sub assembly 4. The twelve (12) tamperproof stainless steel screws 11 also support plastic spacers 25 and the solid-state light panels 14, with stainless steel nuts 26.

Plastic spacers 25 maintain a uniform distance between the solid state LED light panel 14 and the plexiglas/ Lexan shield 13. The stainless steel panel 39 contains a slot 38 that lets through light from the solid state LED light panel 14 via the plexiglas/Lexan shield 13.

Each light panel sub assembly 4 attaches to the enclosure 3 in FIG. 2 through holes 22.

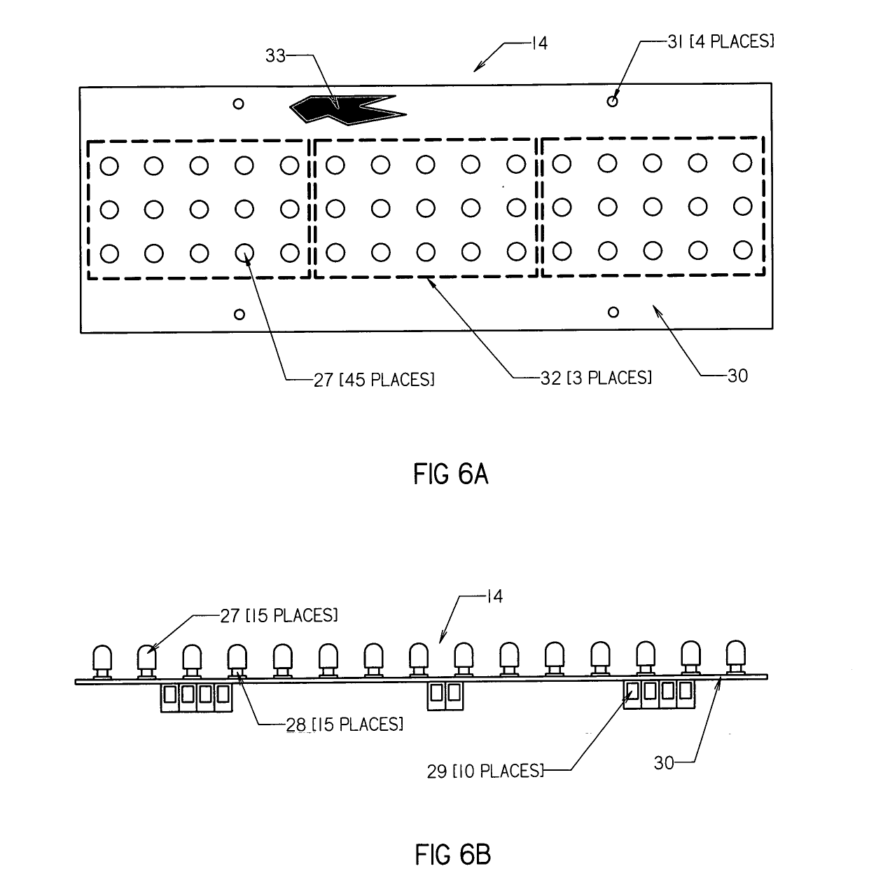

The solid-state light panel 14 in FIGS. 6A and 6B consists of a printed circuit board 30, ten terminal blocks 29, and forty-five (45) discrete Light Emitting Diode [LED] elements 27. The LED elements 27 are positioned away from the printed circuit board 30 with plastic spacers 28. These plastic spacers 28 allow for adjustment/alignment of each LED element 27, and prevent overheating of the LED elements 27 during soldering.

Each solid-state light panel 14 has four (4) mounting holes 31.

The printed circuit board 30 has a dark solder mask 33 over the entire top of the board. The solder mask 33 provides a contrasting background for the LED elements 27 to allow for better visibility, particularly during daylight hours. To further improve daytime visibility, hoods may be mounted on the enclosure.

On the printed circuit board 30, the LED elements 27 comprise three equal-sized independent light blocks 32. Each light block 32 consists of fifteen (15) LED elements 27. As illustrated earlier in FIG. 5B, each light panel sub assembly 4 utilizes three solid-state LED light panels 14. This results in nine independent light blocks 32 per light panel sub assembly 4. The number and size of the light blocks 32—and the number and color of LED elements 27 contained therein—may be adjusted based on user requirements.

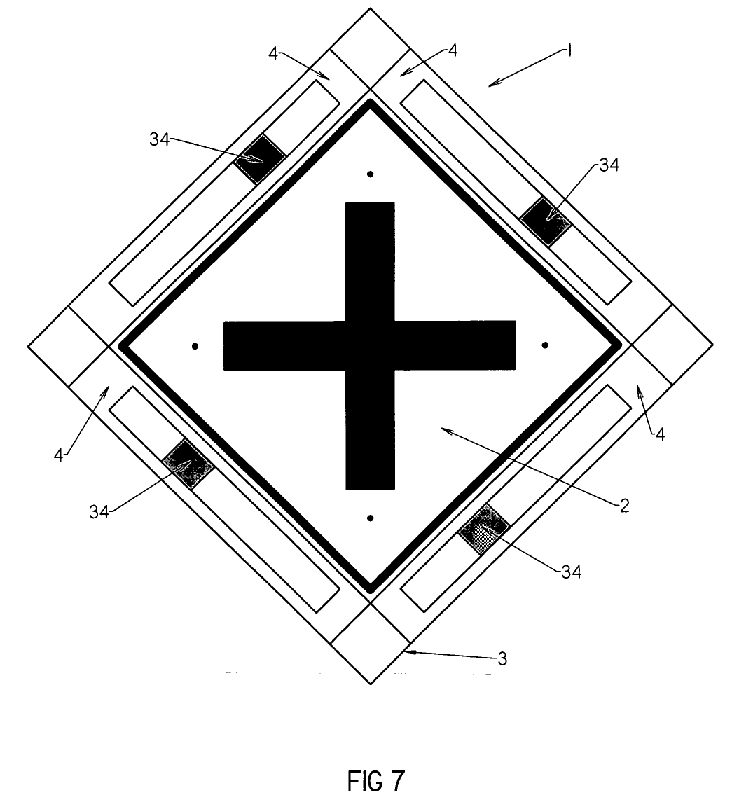

While several flash options may be achieved, the preferred embodiment of the warning system 1 employs a ‘light chaser’ flasher pattern around the road sign 2, as shown in FIG. 7. Select light blocks 34 are activated at specific intervals. When the warning system 1 is active, the same light block 34 position is illuminated on each light panel sub assembly 4. When this position shuts off, the position directly next to that one turns on.

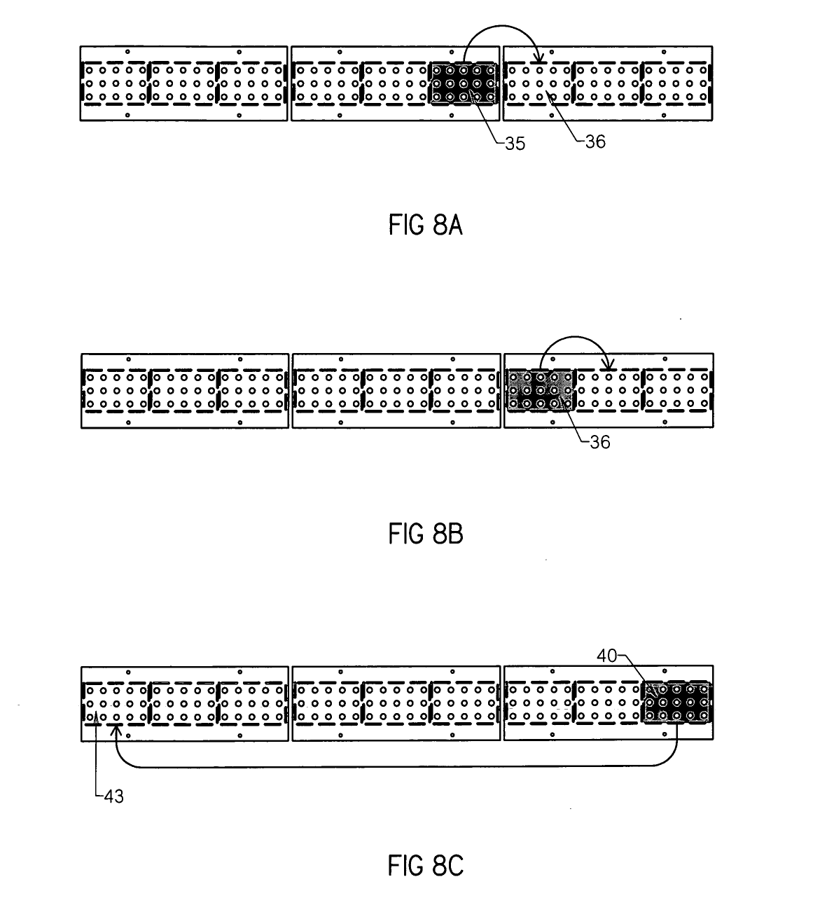

This pattern is further detailed in FIGS. 8A, 8B, and 8C. As illustrated, if the flashing pattern begins on light block 35, then when this block turns off, the light block 36 right next to it turns on. When the ninth light block 40 is reached, the pattern continues with first light block 43, and so on.

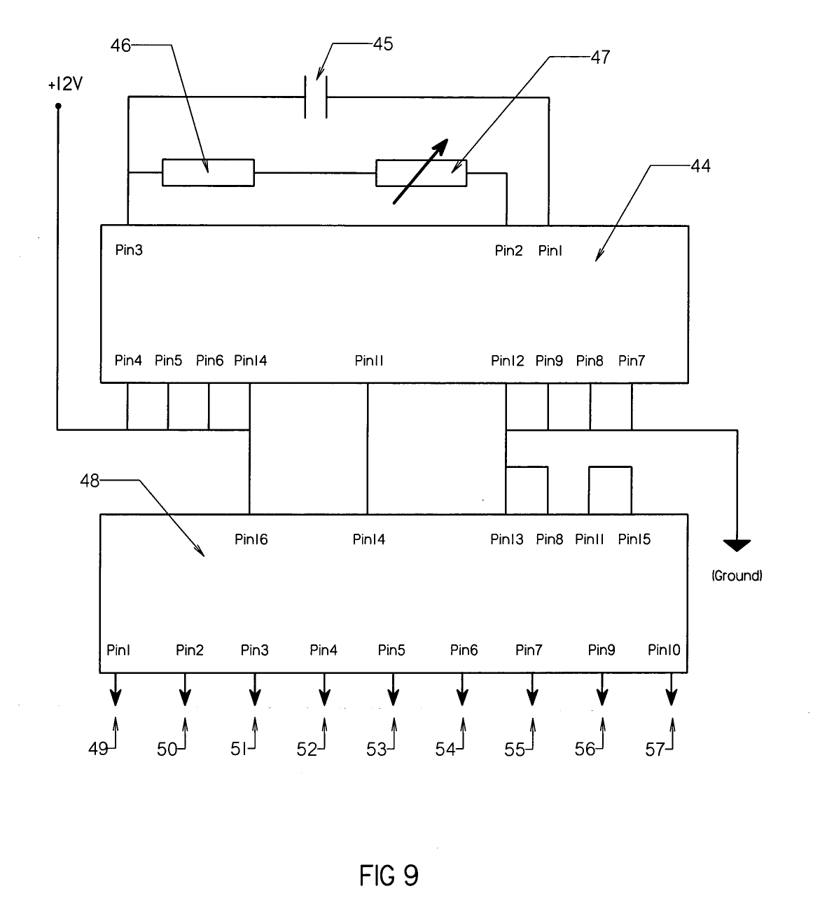

A representative ‘light chaser’ circuit is shown in FIG. 9. This circuit has been designed for 12 volt DC operation, so it suitable for solar and/or battery installations. It can also be powered by line current [AC] if it properly stepped down to 12 volts DC.

An oscillator circuit is comprised of an integrated circuit multivibrator [i.e. CD4047] 44, capacitor 45, resistor 46, and potentiometer 47. With the pin connections as shown, the multivibrator 44 is configured as a free-running oscillator whose frequency is defined by capacitor 45 and resistor 46, and is fine-tuned by potentiometer 47.

For an output frequency of 5 hertz, capacitor 45 has a value of 0.56 uF, resistor 46 has a value of 51K ohms, and the potentiometer 47 has a maximum value of 100K ohms.

The output from the pin 11 [Pin11] of the integrated circuit multivibrator 44 is fed into pin 14 [Pin14] of a decade counter integrated circuit [i.e. CD4017] 48. With the pin connections shown, the decade counter integrated circuit 48 is configured as a 1-to-9 counter circuit with reset. This circuit has nine outputs 49, 50, 51, 52, 53, 54, 55, 56, 57.

When the circuit is turned on, one of these outputs will start in the ‘on’ position—the other eight outputs will be ‘off’. With each pulse from pin 11 [Pin11] of the multivibrator 44, these outputs will increment. As an example, if output 51 was ‘on’ with the current oscillator pulse, then with the next pulse output 51 will turn ‘off’ and output 52 will turn ‘on’. Once output 57 is reached, the 1-to-9 counter recycles, so on the next oscillator pulse it returns to output 49.

The outputs 49, 50, 51, 52, 53, 54, 55, 56, 57 are subsequently used to drive solid-state relays which, in turn, are used to control the individual light blocks shown earlier in FIG. 7 and FIGS. 8A, 8B, and 8C

Having now fully set forth the preferred embodiments and certain modifications of the concept underlying the present invention, various other embodiments as well as certain variations and modifications to the embodiment herein shown and described will obviously occur to those skilled in the art upon becoming familiar with said underlying concept. It is to be understood therefore, that the invention may be practiced otherwise than specifically set forth in the appended claims, and that various changes may be made without departing from the spirit and scope of the invention.

I claim the following:

1. A warning system comprising:
An enclosure disposed peripherally about a regulatory, warning, or guide sign that is used for traffic control—and whose shape shall be defined by the perimeter of said sign. For a sign with N sides, the enclosure shall possess N sides.
A warning flasher system consisting of light bars or light panels incorporated into said enclosure. For a road sign with N sides, said warning flasher shall be comprised of a minimum of N light bars/panels.
The length of each light bar/panel shall extend over a minimum of 30% of the length of the side of the road sign to which it is associated.
Each light bar/panel shall be comprised of at least one independently controlled discrete light element.
Each light bar/panel shall incorporate either solid-state light elements [i.e. Light Emitting Diodes] or incandescent light elements.

2. A warning system comprising:
A plurality of discrete enclosure elements disposed peripherally about a regulatory, warning, or guide sign that is used for traffic control. For said sign, the warning system shall possess a minimum of 2 discrete enclosure elements.
A warning flasher system consisting of light bars or light panels incorporated into said enclosure elements. For a road sign with N sides, said warning flasher shall be comprised of a minimum of N light bars/panels.
The length of each light bar/panel shall extend over a minimum of 30% of the length of the side of the road sign to which it is associated.
Each light bar/panel shall be comprised of at least one independently controlled discrete light element.
Each light bar/panel shall incorporate either solid-state light elements [i.e. Light Emitting Diodes] or incandescent light elements.

3. The warning system of claim 1 where the enclosure incorporates a support feature for said regulatory, warning, or guide sign.

4. The warning system of claim 2 where the enclosure elements include a support feature for said regulatory, warning, or guide sign.

5. The warning system of claim 3 where the inner perimeter of said enclosure shall be sized such that it creates a gap for airflow between said sign and the enclosure.

6. The warning system of claim 4 where the inner perimeter created by said enclosure elements shall be sized such that it creates a gap for airflow between said sign and the enclosure elements.

7. The warning system of claim 1 where the warning flasher employs a flashing pattern wherein up to 100% of said discrete light elements are illuminated at the same time.

8. The warning system of claim 2 where the warning flasher employs a flashing pattern wherein up to 100% of said discrete light elements are illuminated at the same time.

9. The warning system of claim 1 where the system employs a steady-state light output wherein up to 100% of said discrete light elements are illuminated at the same time.

10. The warning system of claim 2 where the system employs a steady-state light output wherein up to 100% of said discrete light elements are illuminated at the same time.

11. The warning system of claim 1 wherein each light element is set upon a dark background to increase the daytime visibility of said element/element group—and to sharpen the contrast between ‘on’ and ‘off’ conditions of said light element(s).

12. The warning system of claim 2 wherein each light element is set upon a dark background to increase the daytime visibility of said element/element group—and to sharpen the contrast between ‘on’ and ‘off’ conditions of said light element(s).

13. The warning system of claim 1 wherein hoods are attached to said enclosure to improve daytime visibility of said flasher elements.

14. The warning system of claim 2 wherein hoods are attached to said enclosure elements to improve daytime visibility of said flasher elements.
